(19) United States
(12) Patent Application Publication
(10) Pub. No.: US 2021/0246603 A1
(43) Pub. Date: Aug. 12, 2021

(54) DUCT CONNECTOR ASSEMBLY

(71) Applicant: IMPERIAL MANUFACTURING GROUP INC., Richibucto (CA)

(72) Inventors: Francis KENNY, Richibucto (CA); Luc DAIGLE, Richibucto (CA)

(73) Assignee: IMPERIAL MANUFACTURING GROUP INC., Richibucto (CA)

(21) Appl. No.: 17/169,174

(22) Filed: Feb. 5, 2021

(30) Foreign Application Priority Data
Feb. 7, 2020 (CA) 3071696

(51) Int. Cl. D06F 58/20; D06F 58/10

(52) U.S. Cl. CPC D06F 58/20; F16L 23/22; D06F 58/10

(57) ABSTRACT

The present invention is a duct assembly having a duct connector for use in ventilation. The duct connector has a lipped portion and a gasket secured to the duct connector. The gasket has a slot to receive the lipped portion of the duct connector.

A duct assembly of the present invention may also have a handle to facilitate manipulation of the duct assembly. The handle also has a back stopper to protect a conduit installed to the duct assembly.

### CROSS REFERENCE TO RELATED APPLICATION

The present application claims priority to Canadian Patent Application No. CA 3,071,696, entitled “DUCT CONNECTOR ASSEMBLY” filed on Feb. 7, 2020, the contents of which are incorporated herein by reference in their entirety.

### FIELD

The invention relates to the field of ducts, and more specifically to connector assemblies therefor.

### BACKGROUND

Duct assemblies, that is to say gaskets connected to duct connectors have not gone through many substantial innovations recently. However, there are problems that exist with duct assemblies in the market today that can be improved upon. Specifically, gaskets are typically molded directly onto the connectors or simply slid on the connectors without any actual mechanical connection between the two parts.

Unfortunately, such connections are prone to failures. When disconnecting the connector from a receiving end such as an exhaust port, the gasket can come undone from its connector and remain stuck in the exhaust port. The gasket can also fall down on the floor or be lost during manufacturing of the duct assembly. As such, there is a need for a gasket that can be connected and disconnected from the connector, without coming undone using the traditional force required to disconnect and connect the duct assembly from an exhaust port.

Conduits also connected to duct assemblies may be damages when a duct assembly is connected to a dryer for example. The crushing of conduits is a well know problem in the industry. The handling of a duct assembly is also a problem which requires a solution.

### SUMMARY

In an aspect, the present disclosure provides a duct assembly comprising a duct connector for use in ventilation, the duct connector comprising a lipped portion; and, a gasket secured to the duct connector, the gasket having a slot to receive the lipped portion of the duct connector.

In another aspect, the present disclosure provides a duct assembly having a handle to facilitate manipulation of the duct assembly. The handle also has a back stopper to protect a conduit installed to the duct assembly.

### BRIEF DESCRIPTION OF THE DRAWINGS

The following figures serve to illustrate various embodiments of features of the disclosure. These figures are illustrative and are not intended to be limiting.

FIG. 1 is a perspective view of a duct assembly according to an embodiment of the present disclosure;

FIG. 2 is a cross-sectional perspective view of the duct assembly, according to an embodiment of the present disclosure;

FIG. 2A is an enlarged cross-sectional view of the gasket secured to the lipped portion of the duct connector as shown in FIG. 2, according to an embodiment of the present disclosure;

FIG. 3 is an enlarged cross-sectional view of the gasket, according to an embodiment of the present disclosure;

FIG. 4 is a perspective view of a duct assembly according to another embodiment of the present disclosure;

FIG. 5 is a cross-sectional perspective view of the duct assembly, according to another embodiment of the present disclosure;

FIG. 5A is an enlarged cross-sectional view of the gasket secured to the lipped portion of the duct connector as shown in FIG. 5, according to another embodiment of the present disclosure;

FIG. 6 is a side view of another embodiment of a duct connector assembly having an elbow of 90 degrees with a handle; and,

FIG. 6a is a perspective view of the duct connector assembly shown in FIG. 6 having the handle positioned on the duct connector assembly.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

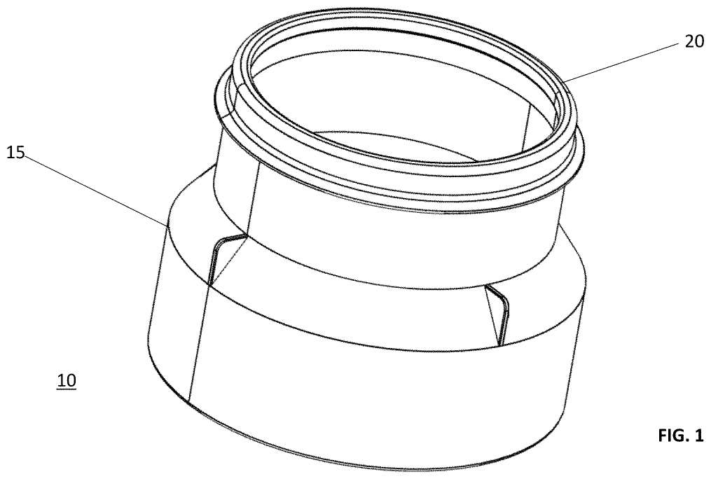

With reference to FIG. 1 and according to an embodiment of the present disclosure, a duct assembly 10 is shown, preferably comprised of a duct connector 15 and a gasket 20. The duct connector 15 is preferably made of plastic material, and further comprised of threading (not shown) on an inside surface thereof, the threading to receive piping as known in the art. Meanwhile, the gasket 20 is preferably made of silicone material to be flexible and better effect contact with a corresponding receiving end and not allow air or other debris to escape the pipe. A worker skilled in the art would appreciate that this particular duct assembly 10 is a male-type connector to be inserted into a wall; however, other duct assemblies to connect to a dryer or other machinery is possible. A worker skilled in the art would further appreciate that although silicone is the preferred material, other materials could be used as long as they can provide sufficient resiliency and flexibility, such as elastomers.

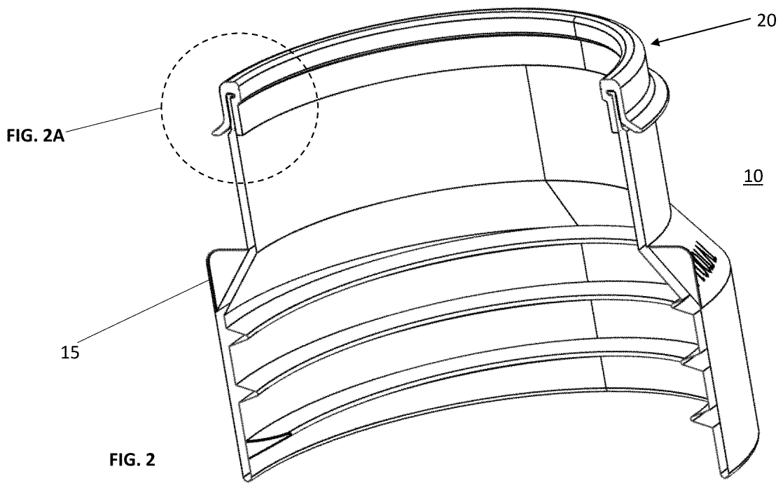

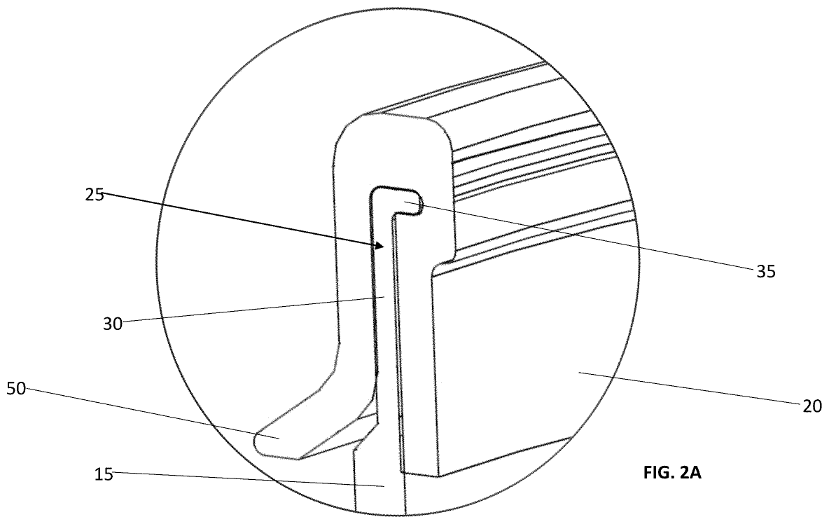

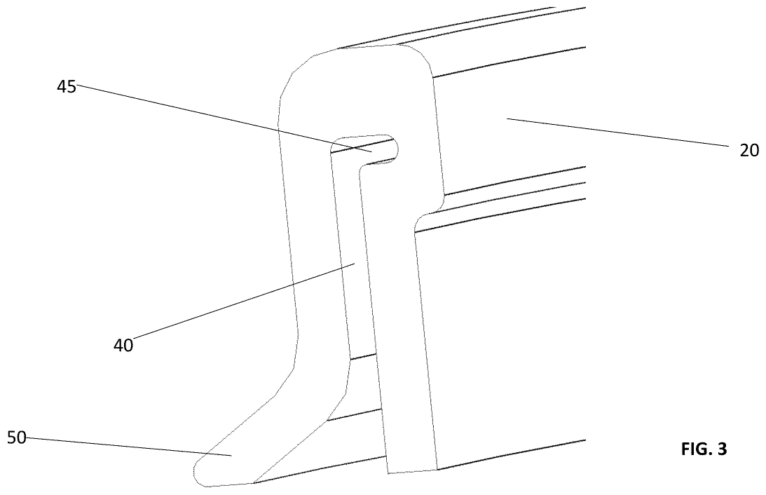

With reference to FIGS. 2, 2A and 3 and according to an embodiment of the present disclosure, the connection between the duct connector 15 and the gasket 20 of the duct assembly is shown in greater detail. Specifically, the duct connector 15 has a circumferential lipped portion 25, the lipped portion 25 further comprised of a longitudinal member 30 terminating in a lip 35. The gasket 20 is further comprised of a circumferential slot 40, the slot 40 to receive the lipped portion 25 of the duct connector 15. A worker skilled in the art would appreciate that the lipped portion 25 is generally L-shaped, corresponding to the general L-shape of the slot 40. To secure the gasket 20 onto the duct connector 15, the lipped portion 25 of the duct connector 15 is aligned with and inserted into the slot 40 of the gasket 20. Although the lip 35 is wider than the width of the slot 40, the gasket is made of silicone material that is flexible and expandable to allow continued insertion of the lipped portion 25 into the slot 40. Once the lip 35 is fitted into the upper region 45 of the slot 40, the lipped portion 25 is secured within the slot 40. Indeed, the shape of the upper region 45 generally corresponds to the shape of the lip 35, and this creates an improved connection between the gasket 20 and the duct connector 15 that is not known in the art. Indeed, the prior art discloses gaskets that are inserted onto or into duct connectors without any lips, such that pulling on a duct connector can often dislodge the gasket if the gasket is tightly connected to a receiving exhaust port. In such cases the gasket can either fall on the floor, remain stuck in the exhaust port or even be lost during transportation of the duct assembly. Those disadvantages are overcome in the present disclosure. The gasket 20 is also comprised of a circumferential flanged portion 50, the flanged portion 50 bendable when the duct assembly 10 is inserted into an orifice of a wall. Indeed, the flanged portion 50 will create a seal between an outer wall of the orifice (not shown) to ensure air and other debris does not escape the connection between the duct assembly 10 and the orifice (not shown).

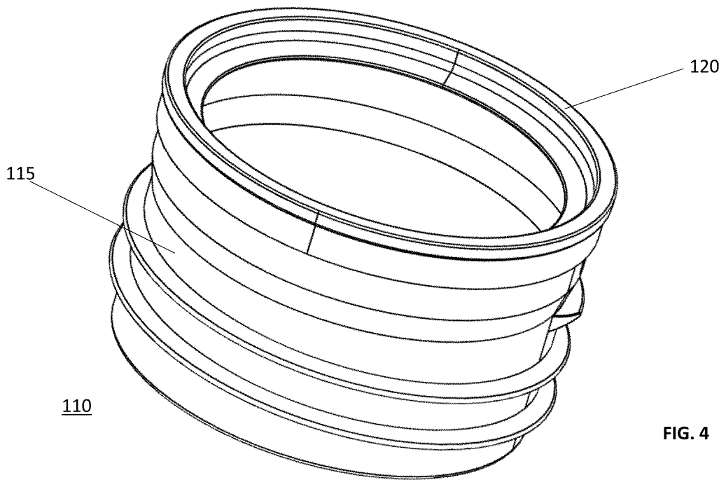

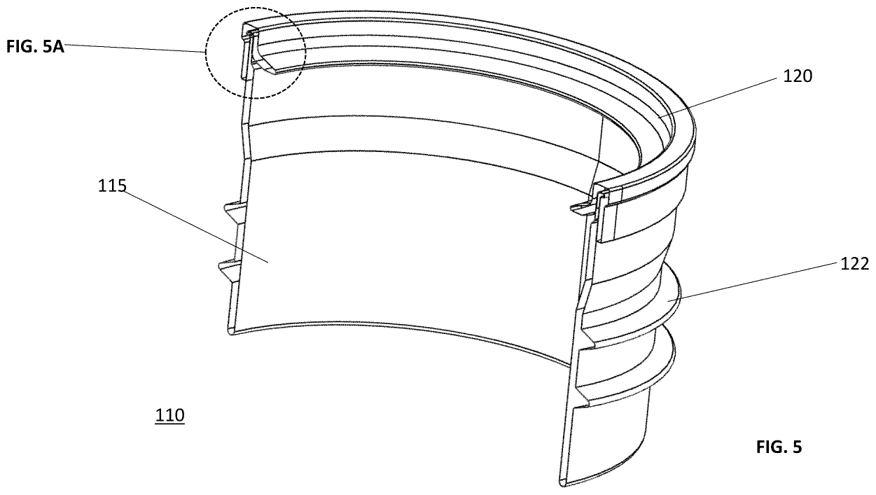

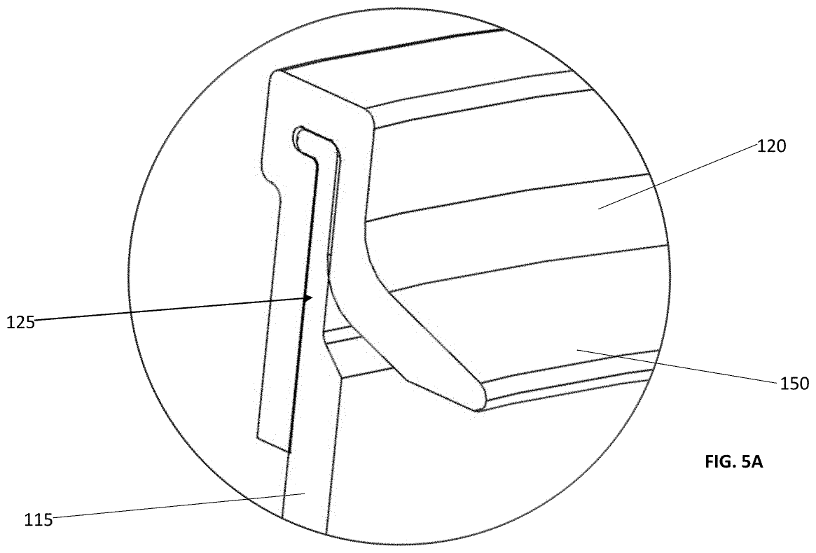

With reference to FIGS. 4, 5 and 5A and according to another embodiment of the present disclosure, a duct assembly 110 is shown, preferably comprised of a connector 115 and a gasket 120. The duct connector 115 is preferably made of plastic material, and further comprised of threading 122 on an outside surface thereof, the threading 122 to receive piping as known in the art. Meanwhile, the gasket 120 is preferably made of silicone material to be flexible and better effect contact with a corresponding receiving end and not allow air or other debris to escape the pipe. A worker skilled in the art would appreciate that this particular duct assembly 110 is a female-type connector to be inserted into a dryer; however, other duct assemblies to connect to or other machinery is possible. In this particular embodiment of the duct assembly 110, the gasket 120 and the duct connector 115 are in a reversed position, that is to say that the lipped portion 125 is reversed, as well as the flanged portion 150 of the gasket 120. As this duct assembly 110 is a female-type connector, it wraps around a corresponding exhaust port of the dryer. The flange 150 would bend and create the airtight seal between the duct assembly 110 and the male receiver to prevent the escape of air and other dust particles. Otherwise, the functioning and assembly of the duct assembly 110 is identical to that of the duct assembly 10.

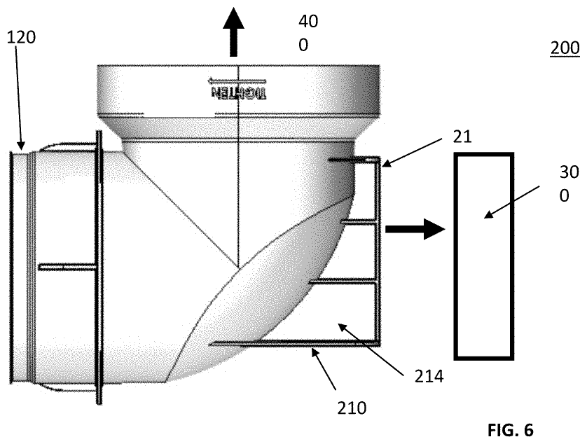

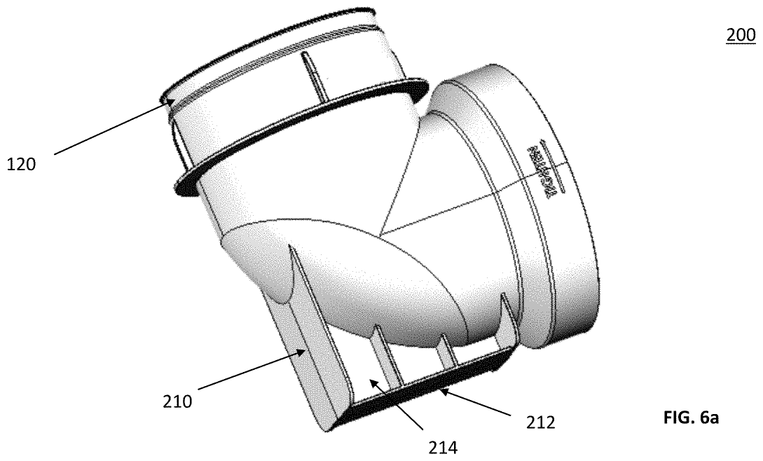

With reference to FIGS. 6 and 6a and according to another embodiment of the present invention, the duct assembly 200 is shown having an elbow of 90 degrees. Duct assembly 200 also has gasket 120 as described in duct assembly 10. A handle 210 is positioned on duct assembly 200 in order to facilitate the installation of duct assembly 200 into a wall or dryer (both not shown). Handle 210 also has a back stopper surface 212 in order to assure a conduit connected to the duct assembly 210 is not crushed against a wall 300 for example.

With further reference to FIG. 6, back stopper surface 212 when pressed against wall 300 assures a conduit (not shown) but its location shown by arrow 400 will not be crushed against wall 300. Handle 210 can have a solid interior 214 or it can be hollow in order to allow fingers or a hand to be positioned within interior portion 214 and to allow a better handling of duct assembly 200.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A duct assembly comprising:
a duct connector for use in ventilation, the duct connector comprising a lipped portion; and,
a gasket secured to the duct connector, the gasket having a slot to receive the lipped portion of the duct connector.

2. The duct assembly of claim 1 wherein the lipped portion is circumferential.

3. The duct assembly of claim 1 wherein the slot is circumferential.

4. The duct assembly of claim 1 wherein the lipped portion is further comprised of a longitudinal member terminating in a lip.

5. The cut assembly of claim 4 wherein the lipped portion is generally L-shaped.

6. The duct assembly of claim 1 wherein the slot is further comprised of an upper region and the slot is generally L-shaped to correspond to a shape of the lipped portion.

7. The duct assembly of claim 1 wherein the gasket is made of a silicone material.

8. The duct assembly of claim 1 wherein the gasket is further comprised of a circumferential flanged portion.

9. The duct assembly of claim 1 wherein the duct connector has threading to connect to a duct pipe.

10. The duct assembly of claim further comprising a handle to manipulate the duct assembly.
